(19) United States
(12) Patent Application Publication
(10) Pub. No.: US 2004/0165082 A1
(43) Pub. Date: Aug. 26, 2004

(54) Image processing apparatus, image processing method and digital still camera

(76) Inventor: Kensuke Takai, Soraku-gun (JP)

Correspondence Address: HARNESS, DICKEY & PIERCE, P.L.C., P.O. BOX 8910, RESTON, VA, 20195, US

(21) Appl. No.: 10/730,988

(22) Filed: Dec. 10, 2003

(30) Foreign Application Priority Data
Dec. 10, 2002 (JP) 2002-358765

(51) Int. Cl. H04N 5/228

(52) U.S. Cl. 348/222.1

(57) ABSTRACT

An image processing apparatus includes a horizontal direction interpolation section for performing data interpolation in a horizontal direction using a plurality of pieces of pixel data adjacent to a first pixel position in the horizontal direction to generate a first color signal; a line memory section for storing the first color signal in units of a plurality of lines; a vertical direction interpolation section for performing data interpolation in a vertical direction using a plurality of pieces of pixel data, among pieces of data output from the line memory section, adjacent to a second pixel position in the vertical direction to generate a second color signal; and a luminance and color difference signal generation section for generating a luminance signal and color difference signals based on the second color signal.

### BACKGROUND OF THE INVENTION

1. Field of the Invention

The present invention relates to an image processing apparatus and an image processing method for generating a luminance signal and a color difference signal using pixel data obtained by an imaging device having a color filter, and a digital still camera including the image processing apparatus.

2. Description of the Related Art

Conventionally, a digital still camera obtains pixel data using, for example, a solid-state imaging device including a plurality of light receiving elements arranged in rows and columns and a color filter provided for each of the plurality of light receiving elements. The image data is converted into a digital value. Then, the image data is subjected by an image processing apparatus to digital clamp processing, white balance processing, luminance signal generation and color difference signal generation and the like. The generated luminance signal and color difference signal are stored in an external memory.

FIG. 9 is a block diagram illustrating an exemplary of a digital still camera 50 including a conventional image processing apparatus.

As shown in FIG. 9, the digital still camera 50 includes a CCD sensor 51 as an imaging device, a sample and hold section 52, an A-D converter 53 and an image processing apparatus 50A.

The image processing apparatus 50A includes a clamp processing section 54, a white balance processing section 55, a gamma (γ) correction section 56, a low pass filter section 57, a thinning-out section 58, a line memory 59, an interpolation section 60, and a luminance and color difference signal generation section 61. The luminance and color difference signal generation section 61 generates Y, CB and CR data.

The CCD sensor 51 includes a plurality of light receiving elements 51A arranged in a matrix, i.e., in rows and columns. Each light receiving element 51A includes a red (R) filter, a green (G) filter or a blue (B) filter. Thus, the plurality of color filters 51B arranged in a matrix form a color filter array. The CCD sensor 5l outputs pixel data representing a color component corresponding to the color filter of the respective color.

The sample and hold section 52 samples and holds the pixel data as the signal component.

The A-D converter 53 converts the sampled and held signal component into digital pixel data.

The clamp processing section 54 in the image processing apparatus 50A fixes the black level of the digital pixel data to a defined value.

The white balance processing section 55 multiplies the R or B digital pixel data by a prescribed value to adjust the gain in order to adjust the white color.

The gamma correction section 56 corrects the brightness of the digital pixel data such that the brightness matches the gradation characteristic of a display device with which the digital still camera 50 is to be used. The display device is, for example, a CRT or liquid crystal panel and is used as a monitoring device.

The low pass filter 57 attenuates a high frequency component of the digital pixel data in order to avoid aliasing which is caused by the subsequent size reduction processing (for example, thinning-out processing).

The thinning-out section 58 thins out the digital pixel data so as to perform size reduction processing in a horizontal direction.

The line memory 59 temporarily stores the digital pixel data which has been reduced by the thinning-out section 58.

The interpolation section 60 obtains a color component which does not exist in the color filter array by interpolation.

The luminance and color difference signal generation section 61 generates a luminance signal Y, and color difference signals CB and CR.

Hereinafter, interpolation will be described.

In a single CCD digital camera, as shown in, for example, FIG. 10A, a color filter 51B of a specific color (R, G or B) is provided for each of the plurality of light receiving elements (pixels) 51A. By processing a signal which is output from each light receiving element 51A corresponding to each color, color separation is performed. Thus, a color signal of each of the R, G and B colors is obtained by calculation. From the color signals, a video signal, such as a luminance signal or a color difference signal, is created.

In FIG. 10A, the colors filters 51B are arranged in the Bayer arrangement; i.e., two colors are arranged alternately in each vertical line and each horizontal line as follows: R, G, R, G, . . . in line 1 from the top and also line 1 from the left; G, B, G, B, . . . in line 2 from the top and also line 2 from the left; R, G, R, G, . . . in line 3 from the top and also line 3 from the left; and G, B, G, B, . . . in line 4 from the top and also line 4 from the left In such an arrangement, for example, a G color signal is not obtained from the light receiving element 51A having an R filter. Therefore, the G color signal of this light receiving element 51A is obtained from adjacent light receiving elements 51A by interpolation. This is possible with the premise that there is a correlation in the light intensity incident on the two adjacent light receiving elements 51A which are used for data interpolation.

The digital still camera 50 has a function called monitoring. Monitoring refers to displaying, in real time, an image captured from an imaging device such as a CCD or the like. This function is provided so that the user can determine a structure of an image when the user takes the image. A digital still camera of a pixel number of as large as one million or greater usually obtains moving picture data corresponding to 30 frames per second. In order to read the moving picture of all the pixels, the amount of data which is output from the imaging device per hour is excessively large. This requires a driving clock to be several times higher. This increases the speed of image processing, but also significantly increases the power consumption.

In order to suppress the power consumption, an operation called a monitoring mode is performed. In this operation, the data is thinned out in the vertical direction by the CCD 51 so as to reduce the amount of pixel data to be output, and pixel data corresponding to 30 or 15 frames is output per second. In the case of, for example, a CCD sensor for 3 million pixels, the amount of data is reduced to about 1/7 by thinning out data in the vertical direction. When data for one line is output, data for six lines is thinned out. When data for the next one line is output, data for another six lines is thinned out. Thus, data is output from every seventh line. In the horizontal direction, data is not usually thinned out and all the data in the horizontal direction is output.

Where a plurality of line memories 59 capable of storing all the pixel data in the horizontal direction are provided, the LSI chip size becomes unpractically large. When, for example, using a line memory 59 capable of storing data for 640 pixels per line in order to display a moving picture, the amount of pixel data in the horizontal direction needs to be reduced before the data is input to the line memory 59. The reduction ratio in the horizontal direction is, for example, about ⅓ for a CCD sensor for 3 million pixels.

As described above, when the data is thinned out in the vertical direction by the CCD sensor 51 in the monitoring operation, the correlation between each two adjacent pieces of pixel data in the vertical direction is often weakened. In the horizontal direction also, data is thinned out in order to allow the line memory 59 for storing the data to have a practical capacity. Therefore, the correlation between each two adjacent pieces of pixel data is often weakened. When interpolation is performed in the state where the correlation between each two adjacent pieces of pixel data is weakened, a problem occurs that a color which does not exist (false color) is generated in the processed image.

Hereinafter, generation of a false color will be described, with reference to FIGS. 10A, 10B, 10C, 11A, 11B and 11C.

It is assumed that in a CCD sensor 51 (solid-state imaging device) having color filters provided in the Bayer arrangement as shown in FIG. 10A, one of two portions vertically arranged (i.e., separated by a horizontal line; for example, an upper portion and a lower portion as shown in FIG. 10B) is irradiated with white light and the other portion is irradiated with no light. In this case, the signal from each of the light receiving elements having an R, G or B filter in the portion irradiated with white light (the upper portion in this example) represents “1”. The signal from each of the light receiving elements having an R, G or B filter in the portion irradiated with no light (the lower portion in this example) represents “0”.

Among these signals, the signals from each two adjacent light receiving elements 51A are averaged or weighted so as to perform interpolation. For example, a filter shown in FIG. 10C is used for weighting. The signals are weighted with a value corresponding to the respective light receiving element, so that the interpolated image data corresponding to the central point in the filtered light receiving elements 51A is obtained. When such a filter is used, the post-interpolation pixel data of central point A of 4×4 pixels in FIG. 10D is obtained as follows.

$$R = ( 1 \times 1 + ( 1 + 0 ) \times 3 + 0 \times 9 ) / 16 = 0.25 \\ B = ( 1 \times 9 + ( 1 + 0 ) \times 3 + 0 \times 1 ) / 16 = 0.75 \\ G = ( ( 1 + 0 ) \times 9 + ( 1 + 1 + 0 + 0 ) \times 3 + ( 1 + 0 ) \times 1 ) ) / 32 \\ = 0.5$$

The color signals CB and CR which are obtained from the post-interpolation R, B and G data values are as follows:

B−G=0.25

R−G=−0.25

Thus,

$$CB = B - Y \\ = ( - 0.299 R - 0.587 G + 0.886 B ) \times 0.564 \\ = ( ( B - G ) - ( R - G ) \times 0.337 ) \times 0.5 \\ = 0.167 \\ CR = R - Y \\ = ( 0.701 R - 0.587 G - 0.114 B ) \times 0.713 \\ = ( ( R - G ) - ( B - G ) \times 0.163 ) \times 0.5 \\ = - 0.145$$

The purpose of this description is to explain that the color difference signals CB and CR are not 0 and a false signal is generated. Therefore, detailed conversion formulas into the luminance signal Y and the color difference signals CB and CR, and the value of the luminance signal Y are omitted.

As described above, at the border between the portion irradiated with white light and the portion irradiated with no light, the color difference signals CB and CR are not “0” although they are supposed to be “0”. Thus, a false signal is generated. When data is thinned out by a CCD sensor in the vertical direction, the correlation between each two adjacent pieces of pixel data is often weakened. As a result, generation of such a false color is conspicuous.

It is also assumed that one of two portions horizontally arranged (i.e., separated by a vertical line; for example, a left portion and a right portion as shown in FIG. 11A) is irradiated with white light, and the other portion is irradiated with no light. In this case, the signal from each of the light receiving elements having an R, G or B filter in the portion irradiated with white light (the right portion in this example) represents “1”. The signal from each of the light receiving elements having an R, G or B filter in the portion irradiated with no light (the left portion in this example) represents “0”. At the border between the two portions, the signal from each of the light receiving elements having an R, G or B filter represents “0.5”.

FIG. 11B shows ⅓ thinning-out processing. Data represented by the arrows is thinned out, so that the data in the thick-lined rectangles is left. Then, interpolation is performed by weighting using the filter shown in FIG. 11C. Then, the post-interpolation pixel data at point B in FIG. 11C is obtained as follows.

$$R = ( 0 \times 1 + ( 1 + 0 ) \times 3 + 1 \times 9 ) / 16 = 0.75 \\ B = ( 0 \times 9 + ( 1 + 0 ) \times 3 + 1 \times 1 ) / 16 = 0.25 \\ G = ( ( 1 + 0 ) \times 9 + ( 1 + 1 + 0 + 0 ) \times 3 + ( 1 + 0 ) \times 1 ) ) / 32 \\ = 0.5$$

The color signals CB and CR are as follows:

B−G=0.25

R−G=−0.25

Thus,

$$CB = B - Y \\ = ( - 0.299 R - 0.587 G + 0.886 B ) \times 0.564 \\ = ( ( B - G ) - ( R - G ) \times 0.337 ) \times 0.5 \\ = - 0.167$$

$$CR = R - Y \\ = ( 0.701 R - 0.587 G + 0.114 B ) \times 0.713 \\ = ( ( R - G ) - ( B - G ) \times 0.163 ) \times 0.5 \\ = 0.145$$

The post-interpolation pixel data at point C in FIG. 11C is obtained as follows.

$$R = ( 0 \times 1 + ( 0 + 1 ) \times 3 + 1 \times 9 ) / 16 = 0.75 \\ B = ( 1 \times 9 + ( 1 + 1 ) \times 3 + 1 \times 1 ) / 16 = 1 \\ G = ( ( 1 + 1 ) \times 9 + ( 1 + 1 + 1 + 0 ) \times 3 + ( 1 + 0 ) \times 1 ) ) / 32 \\ = 0.875$$

The color signals CB and CR are as follows:

B−G=−0.125

R−G=0.125

Thus,

$$CB = B - Y \\ = ( - 0.299 R - 0.587 G + 0.886 B ) \times 0.564 \\ = ( ( B - G ) - ( R - G ) \times 0.337 ) \times 0.5 \\ = 0.084$$

$$CR = R - Y \\ = ( 0.701 R - 0.587 G - 0.114 B ) \times 0.713 \\ = ( ( R - G ) - ( B - G ) \times 0.163 ) \times 0.5 \\ = - 0.073$$

As described above, the color difference signals CB and CR are not “0”although they are supposed to be “0”. Thus, a false signal is generated. The reason is that when data is thinned out in the horizontal direction, the correlation between each two adjacent pieces of pixel data is often weakened.

As described above, when pixel data is thinned out, it becomes difficult to obtain a correct color difference signal by interpolation and a false color is generated. Japanese Laid-Open Publications Nos. 2000-78595 and 2001-86520 each disclose a method for solving this problem. By these methods, after pixel data is thinned out, data corresponding to a plurality of lines is stored in the line memory 59, and interpolation or the like is performed using the data corresponding to the plurality of lines. Thus, generation of a false color is suppressed even when data is thinned out in the vertical direction.

As described above, when pixel data is thinned out in the vertical direction in the monitoring operation, the correlation between each two adjacent pieces of pixel data is often weakened. When data is thinned out in the horizontal direction in order to allow the line memory for storing the data to have a practical capacity, the correlation between each two adjacent pieces of pixel data is often weakened. When interpolation is performed in such a state, a false color which does not exist is generated in the processed image.

### SUMMARY OF THE INVENTION

According to an aspect of the invention, an image processing apparatus for generating a luminance signal and color difference signals based on pixel data which is input from an imaging device is provided. The imaging device includes a plurality of light receiving sections arranged in rows and columns. The plurality of light receiving sections each include a color filter. The image processing apparatus includes a horizontal direction interpolation section for performing data interpolation in a horizontal direction using a plurality of pieces of pixel data adjacent to a first pixel position in the horizontal direction to generate a first color signal; a line memory section for storing the first color signal in units of a plurality of lines; a vertical direction interpolation section for performing data interpolation in a vertical direction using a plurality of pieces of pixel data, among pieces of data output from the line memory section, adjacent to a second pixel position in the vertical direction to generate a second color signal; and luminance and color difference signal generation section for generating a luminance signal and color difference signals based on the second color signal.

In one embodiment of the invention, the horizontal direction interpolation section includes a horizontal direction interpolation circuit for, when the color filters are provided in a Bayer arrangement, outputting an R data signal based on an RG line, outputting a B data signal based on a GB line, and outputting a G data signal based on the RG line and the GB line; and a differential signal output section for outputting a first differential signal based on the R data signal and the G data signal and outputting a second differential signal based on the B data signal and the G data signal.

In one embodiment of the invention, the horizontal direction interpolation section includes a four-stage shift register section for sequentially holding a plurality of pieces of pixel data; a first addition section for adding pieces of data output from odd-numbered stages of the shift register; a second addition section for adding pieces of data output from even-numbered stages of the shift register; a first selection section for selecting one of the data output from the first, addition section and the data output from the second addition section so as to output one of an R data signal and a B data signal; and a second selection section for selecting one of the data output from the first addition section and the data output from the second addition section so as to output a G data signal.

In one embodiment of the invention, the line memory section thins out the first color signal in the horizontal direction and stores the thinned-out first color signal therein.

In one embodiment of the invention, the line memory section includes a first line memory for receiving the first differential signal and the second differential signal; a second line memory for receiving the data signal output from the first line memory; a third line memory for receiving the data signal output from the second line memory; a fourth line memory for receiving the G data signal; a fifth line memory for receiving the data signal output from the fourth line memory; and a sixth line memory for receiving the data signal output from the fifth line memory.

In one embodiment of the invention, the vertical direction interpolation section receives the first differential signal, the second differential signal, the G data signal, and the data signal from each of the first through sixth line memories.

In one embodiment of the invention, the image processing apparatus further includes an intermittent clock signal generation section for generating an intermittent clock signal having a frequency lower than a frequency of a clock signal which is input to the horizontal direction interpolation section; wherein the line memory section, the vertical direction interpolation section, and the luminance and color difference signal generation section operate based on the intermittent clock signal.

In one embodiment of the invention, the horizontal direction interpolation section generates the first color signal using a filter for weighting at least one of the plurality of pieces of pixel data adjacent to the first pixel position in the horizontal direction. The vertical direction interpolation section generates the second color signal using a filter for weighting at least one of the plurality of pieces of pixel data adjacent to the second pixel position in the vertical direction.

According to another aspect of the invention, a digital still camera includes an imaging device; and an image processing apparatus for generating a luminance signal and color difference signals based on pixel data which is input from the imaging device. The imaging device includes a plurality of light receiving sections arranged in rows and columns. The plurality of light receiving sections each include a color filter. The image processing apparatus includes a horizontal direction interpolation section for performing data interpolation in a horizontal direction using a plurality of pieces of pixel data adjacent to a first pixel position in the horizontal direction to generate a first color signal; a line memory section for storing the first color signal in units of a plurality of lines; a vertical direction interpolation section for performing data interpolation in a vertical direction using a plurality of pieces of pixel data, among pieces of data output from the line memory section, adjacent to a second pixel position in the vertical direction to generate a second color signal; and a luminance and color difference signal generation section for generating a luminance signal and dolor difference signals based on the second color signal.

According to still another aspect of the invention, an image processing method for generating a luminance signal and color difference signals based on pixel data which is input from an imaging device is provided. The imaging device includes a plurality of light receiving sections arranged in rows and columns. The plurality of light receiving sections each include a color filter. The image processing method includes a first step of performing data interpolation in a horizontal direction using a plurality of pieces of pixel data adjacent to a first pixel position in the horizontal direction to generate a first color signal; a second step of storing the first color signal in units of a plurality of lines; a third step of performing data interpolation in a vertical direction using a plurality of pieces of pixel data, among pieces of data represented by the first color signal, adjacent to a second pixel position in the vertical direction to generate a second color signal; and a fourth step of generating a luminance signal and color difference signals based on the second color signal.

In one embodiment of the invention, the image processing method further includes the step of generating an intermittent clock signal having a frequency lower than a frequency of a clock signal used at the first step, wherein the second through fourth steps are executed based on the intermittent clock signal.

According to the present invention, pixel data which is input from an imaging device to an image processing apparatus is input to a horizontal direction interpolation section. The horizontal direction interpolation section interpolates data in a horizontal direction using a plurality of pieces of pixel data adjacent to a prescribed pixel position. Thus, R, G and B data signals are generated, and a first color signal (R-G, G-B, G) is generated. In the horizontal direction interpolation, among the pieces of pixel data adjacent to the prescribed pixel position, data corresponding to a specified color is averaged or weighted using a filter, so as to obtain interpolation data. Since the horizontal direction interpolation can be performed using the data before being thinned out in the horizontal direction, the correlation between the adjacent pieces of data is relatively large and therefore a false color is not likely to be generated.

Data corresponding to a plurality of lines of the first color signal which is generated in the horizontal direction interpolation section is stored in a line memory for color difference signals (R-G, B-G) and a line memory for G signals.

At this point, an intermittent clock signal is generated by thinning out a basic clock signal at a prescribed ratio by the intermittent clock generation section. The basic clock signal represents an input rate of pixel data. The intermittent clock signal is supplied as an operation clock for a line memory section. By thinning out the first color signal from the horizontal direction interpolation section in the horizontal direction, the capacity of the line memory can be reduced.

The first color signals of a plurality of lines which are output from the line memory (R-G, B-G, G) are input to the vertical direction interpolation section. The vertical direction interpolation section interpolates data using a plurality of pieces of data adjacent to the prescribed pixel position in a vertical direction. Thus, a second color signal (R-G, B-G, G) is generated. The vertical direction interpolation can be performed using a filter for, among the plurality of pieces of pixel data adjacent to the prescribed pixel position, averaging or weighting the pixel data corresponding to a specified color. The first color signal (R-G, B-G, G) is created from the information in the horizontal direction. Therefore, even when the correlation between the adjacent pieces of pixel data is weak, a false color is not likely to be generated.

The second color signal generated by the vertical direction interpolation section is input to the luminance and color difference signal generation section. The luminance and color difference signal generation section generates a luminance signal Y and color difference signals CB and CR.

By using an intermittent clock as the operation clock of the line memory section, the vertical direction interpolation section, and the luminance and color difference signal generation section, the operating frequency of these sections is reduced and the power consumption is decreased.

Thus, the invention described herein makes possible the advantages of providing an image processing apparatus and an image processing method for suppressing generation of a false color even when the correlation between two adjacent pieces of pixel data is weakened by thinning-out processing of the data in a vertical direction or a horizontal direction, and a digital camera including such an image processing apparatus.

These and other advantages of the present invention will become apparent to those skilled in the art upon reading and understanding the following detailed description with reference to the accompanying figures.

### BRIEF DESCRIPTION OF THE DRAWINGS

FIG. 1 is a block diagram illustrating a partial structure of a digital still camera according to one example of the present invention;

FIG. 2 is a block diagram illustrating a horizontal direction interpolation section, a line memory, a vertical direction interpolation section, a luminance and color difference signal generation section, and a thinning-out clock control section shown in FIG. 1;

FIG. 3 is a block diagram of the horizontal direction interpolation circuit shown in FIG. 2;

FIG. 4 is a block diagram of the line memory shown in FIG. 2;

FIG. 5 is a block diagram of the vertical direction interpolation section shown in FIG. 2;

FIG. 6A through 6E illustrate a process for calculating a luminance signal and color difference signals when a portion of the CCD sensor in FIG. 1 is irradiated with white light and another portion thereof is irradiated with no light, the portions being separated by a horizontal line;

FIG. 7A through 7E illustrate a process for calculating a luminance signal and color difference signals when a portion of the CCD sensor in FIG. 1 is irradiated with white light and another portion thereof is irradiated with no light, the portions being separated by a vertical line;

FIG. 8A through 8C illustrate a process for calculating a luminance signal and color difference signals when a portion of the CCD sensor in FIG. 1 is irradiated with white light and another portion thereof is irradiated with no light, the portions being separated by a vertical line;

FIG. 9 is a block diagram illustrating a digital still camera including a conventional image processing apparatus;

FIGS. 10A through 10D illustrate a process for calculating a luminance signal and color difference signals when a portion of a CCD sensor is irradiated with white light and another portion thereof is irradiated with no light, the portions being separated by a horizontal line; and

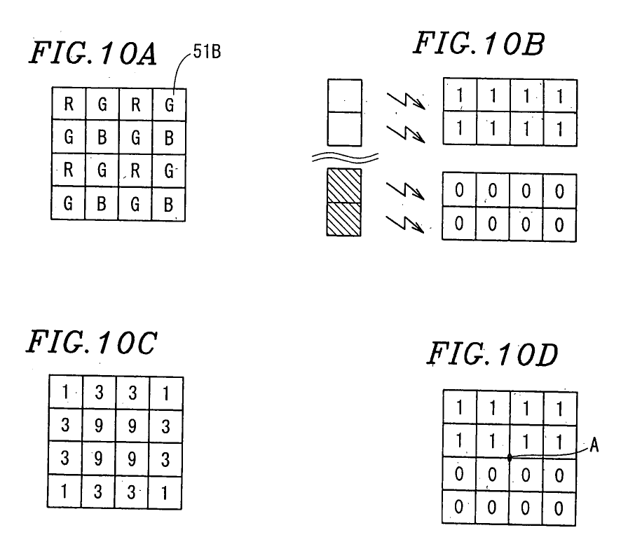

FIGS. 11A through 11C illustrate a process for calculating a luminance signal and color difference signals when a portion of a CCD sensor is irradiated with white light and another portion thereof is irradiated with no light, the portions being separated by a vertical line.

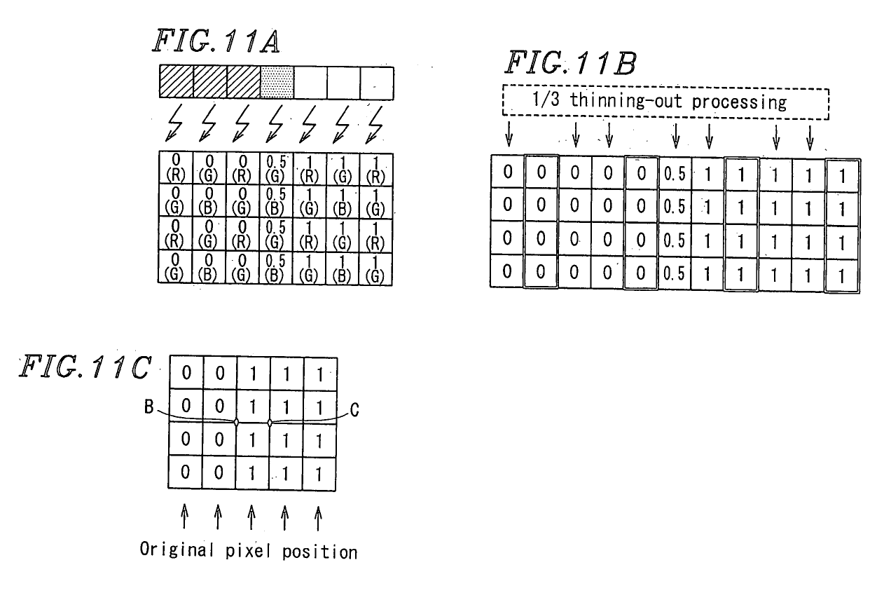

### DESCRIPTION OF THE PREFERRED EMBODIMENTS

Hereinafter, the present invention will be described by way of illustrative examples with reference to the accompanying drawings.

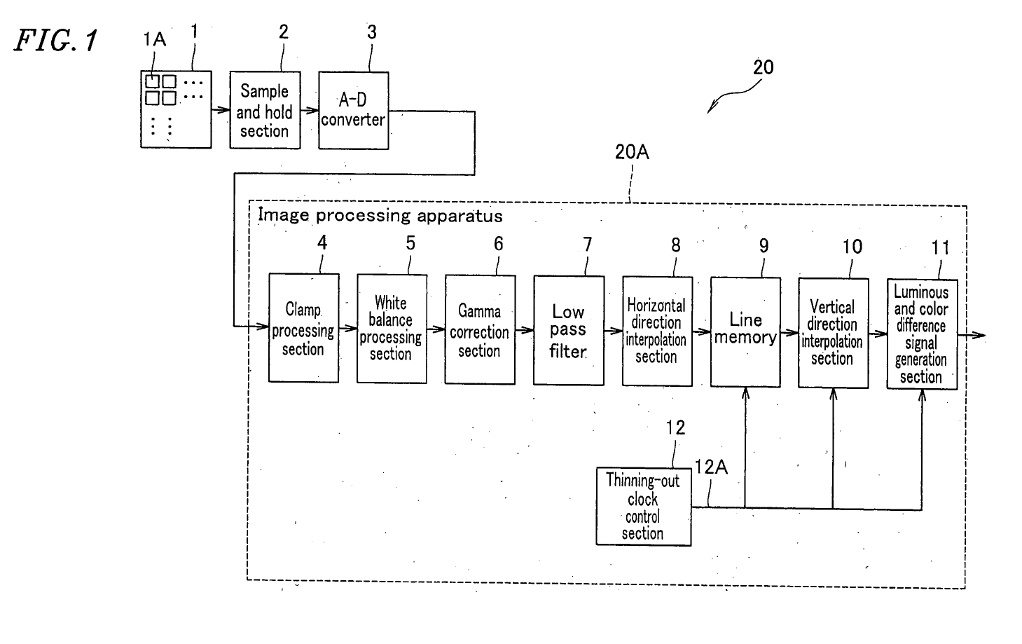

FIG. 1 is a block diagram illustrating a digital camera 20 according to one example of the present invention.

As shown in FIG. 1, the digital still camera 20 includes a CCD sensor 1 as an imaging device, a sample and hold section 2, an A-D converter 3 and an image processing apparatus 20A. The image processing apparatus 20A includes a clamp processing section 4, a white balance processing section 5, a gamma (γ) correction section 6, a low pass filter section 7, a horizontal direction interpolation section 8, a line memory 9, a vertical direction interpolation section 10, a luminance and color difference signal generation section 11 and a thinning-out clock control section 12.

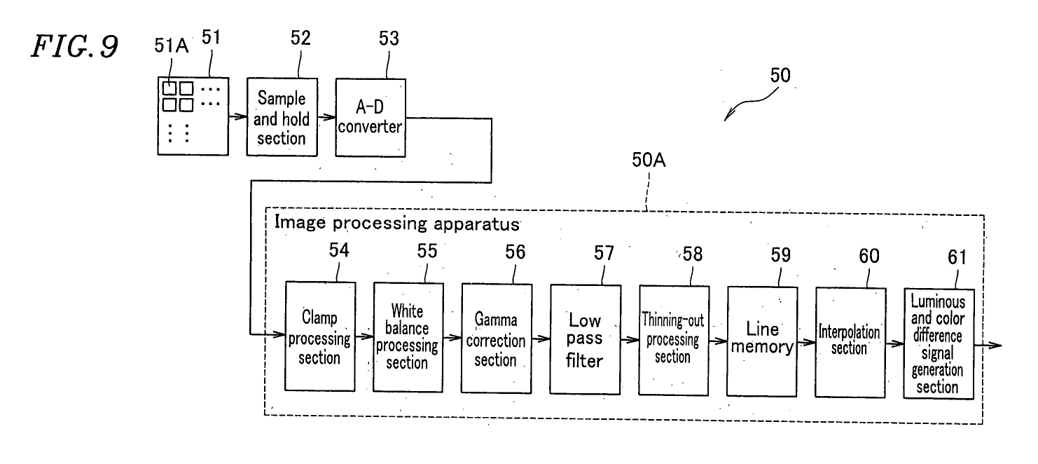

The CCD sensor 1, the sample and hold section 2, the A-D converter 3, the clamp processing section 4, the white balance processing section 5, the gamma correction section 6, and the low pass filter section 7 operate in substantially the same manner as the CCD sensor 51, the sample and hold section 52, the A-D converter 53, the clamp processing section 54, the white balance processing section 55, the gamma correction section 56, and the low pass filter section 57 shown in FIG. 9. The luminance and color difference signal generation section 11 generates a luminance signal Y and color difference signals CB and CR.

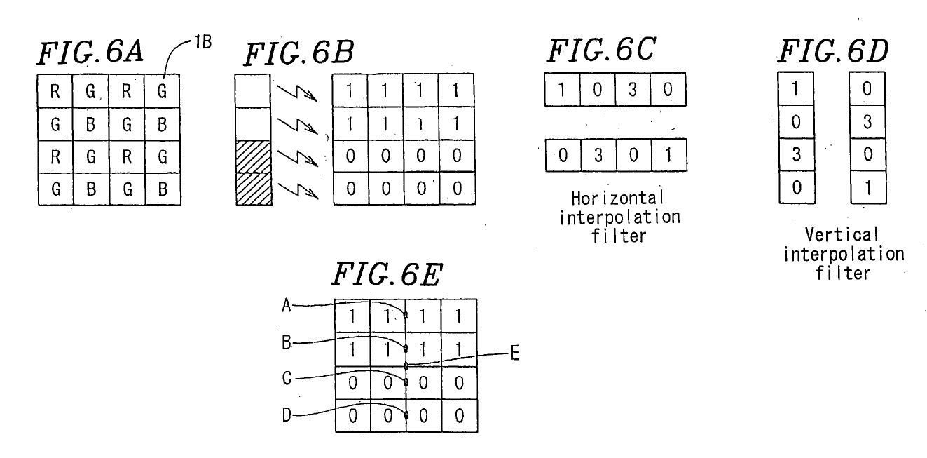

The CCD sensor 1 includes a plurality of light receiving elements 1A arranged in a matrix, i.e., in rows and columns. Each light receiving element 1A includes a red (R) filter, a green (G) filter or a blue (B) filter 1B (FIG. 6A). Thus, the plurality of color filters 1B arranged in a matrix form a color filter array. The light receiving elements 1A are each, for example, a photodiode. The CCD sensor 1 outputs pixel data representing a color component corresponding to the color filter of the respective color.

The sample and hold section 2 samples and holds the pixel data as the signal component.

The A-D converter 3 converts the sampled and held signal component into digital pixel data.

The clamp processing section 4 in the image processing apparatus 20A fixes the black level of the digital pixel data to a defined value.

The white balance processing section 5 multiplies the R or B digital pixel data by a prescribed value to adjust the gain in order to adjust the white color.

The gamma correction section 6 corrects the brightness of the digital pixel data such that the brightness-matches the gradation characteristic of a display device with which the digital still camera 20 is to be used. The display device is, for example, a CRT or liquid crystal panel and is used as a monitoring device.

The low pass filter 7 attenuates a high frequency component of the digital pixel data in order to avoid aliasing which is caused by the subsequent size reduction processing (for example, thinning-out processing).

The horizontal direction interpolation section 8 interpolates data in the horizontal direction and generates a first color signal (R-G, B-G, G) corresponding to a prescribed pixel position. For example, in the case of the Bayer arrangement shown in FIG. 6A, R, G, and R-G data signals are generated from an odd-numbered horizontal line (RG line), and B, G, and B-G data signals are generated from an even-numbered horizontal line (GB line).

The line memory 9 stores the first color signal from the horizontal direction interpolation section 8 corresponding to a plurality of lines.

The vertical direction interpolation section 10 interpolates data in the vertical direction and generates a second color signal (R-G, B-G, G) corresponding to a prescribed pixel position.

The luminance and color difference signal generation section 11 generates a luminance signal Y and color difference signals CB and CR from the second color signal.

The thinning-out clock control section 12 generates a thinned-out, intermittent clock signal 12A which is obtained by thinning-out data of a basic clock signal, at a prescribed ratio, and supplies the thinned-out, intermittent clock signal 12A to the line memory 9 as an operation clock signal. The basic clock signal represents an input rate of pixel data. The intermittent clock signal 12A has a frequency lower than a frequency of a basic clock signal which is input to the horizontal direction interpolation section 8. Using the intermittent clock signal 12A, the line memory 9 horizontally performs thinning-out processing of the first color signal obtained from the horizontal direction interpolation section 8 and stores the resultant data therein. The intermittent clock signal 12A is also used as an operation clock signal for the vertical direction interpolation section 10 and the luminance and color difference signal generation section 11. The operating frequency of the line memory 9, the vertical direction interpolation section 10 and the luminance and color difference signal generation section 11 is reduced, to decrease the power consumption.

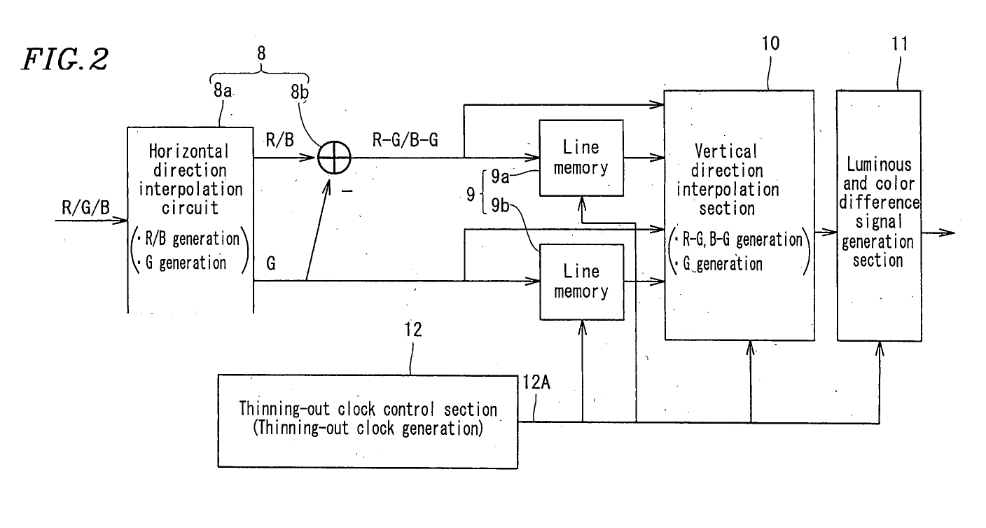

FIG. 2 is a block diagram of a part of the image processing apparatus 20A illustrating the elements of horizontal direction interpolation section 8 and thereafter.

As shown in FIG. 2, the horizontal direction interpolation section 8 includes a horizontal direction interpolation circuit 8a and an adder 8b as an output section for a differential signal. The horizontal direction interpolation circuit 8a performs interpolation in the horizontal direction using pieces of pixel data at pixels adjacent to a prescribed pixel position. Thus, when processing data in an RG line, the horizontal direction interpolation circuit 8a generates R and G data signals. When processing data in a GB line, the horizontal direction interpolation circuit 8a generates B and G data signals. The generated data signals are subjected to subtraction by the adder 8b, and thus a first color signal R-G or B-G is generated after horizontal direction interpolation. The first color signals R-G, B-G and G are output to the vertical direction interpolation section 10 directly or via a line memory 9a or 9b included in the line memory 9.

The vertical direction interpolation section 10 performs interpolation in the vertical direction using pieces of pixel data at pixels adjacent to a prescribed pixel position. Thus, the vertical direction interpolation section 10 generates second data signals R-G, B-G and G.

The luminance and color difference signal generation section 11 generates a luminance signal Y and color difference signals CB and CR using the second data signals R-G, B-G and G generated by the vertical direction interpolation section 10.

The operations of line memories 9a and 9b, the vertical direction interpolation section 10, and the luminance and color difference signal generation section 11 are controlled by the intermittent clock signal 12A generated by the thinning-out clock control section 12.

The horizontal direction interpolation section 8 will be described in detail.

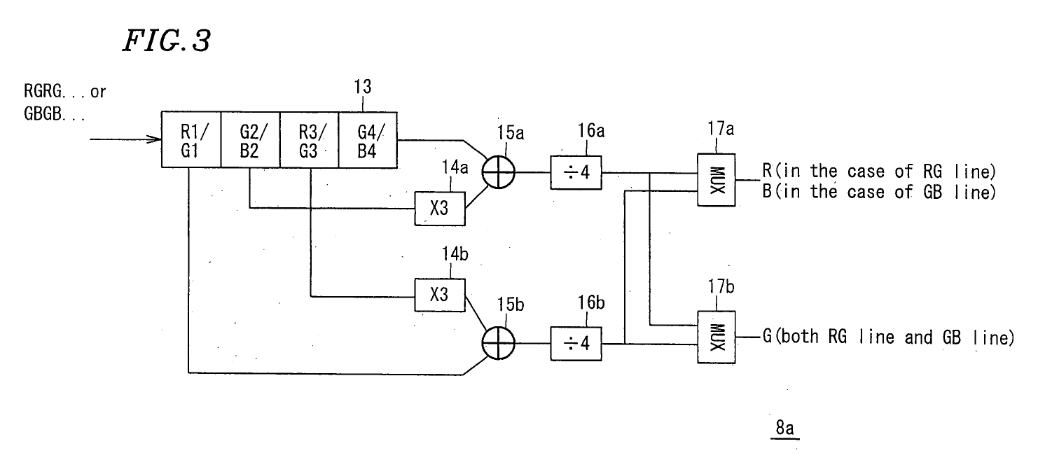

FIG. 3 is a block diagram of the horizontal direction interpolation circuit 8a shown in FIG. 2. The horizontal direction interpolation circuit 8a uses a filter for obtaining data for one pixel from data for four pixels to obtain interpolation data for a pixel located at the center of the four pixels.

As shown in FIG. 3, the horizontal direction interpolation circuit 8a includes a shift register 13 as a four-stage shift register section, multipliers 14a and 14b, an adder 15a as a first adding section, an adder 15b as a second adding section, dividers 16a and 16b, a multiplexer (MUX) 17a as a first selection section, and a multiplexer (MUX) 17b as a second selection section. The horizontal direction interpolation circuit 8a puts a weight of 3 or 1 to pixel data temporarily stored in the shift register 13, adds the weighted data, and divides the added value by 4. Thus, linear interpolation of data at a prescribed pixel position is performed.

For an RG line, the shift register 13 temporarily stores pixel data corresponding to four lines of R1, G2, R3 and G4. After processing the data, the operation is shifted to the right. The shift register 13 temporarily stores pixel data corresponding to the next four lines. This operation is repeated. After processing the data of the RG line, data of the next line, i.e., GB line, is processed.

The shift register 13 temporarily stores pixel data corresponding to four lines of G1, B2, G3 and B4. After processing the data,the operation is shifted to the right. The shift register 13 temporarily stores pixel data corresponding to the next four lines. This operation is repeated. After processing the data of the GB line, data of the next line, i.e., RG line, is processed.

In the RG line, the data is alternately changed as R, G, R, G, . . . . In the GB line, the data is alternately changed as B, G, B, G, . . . . Therefore, the output data is switched over by the multiplexers 17a and 17b. The multiplexer 17a outputs an R data signal while data of RG lines is being processed, and outputs a B data signal while data of GB lines is being processed. The multiplexer 17b outputs a G data signal while data of the RG lines is being processed and also while data of the GB lines is being processed.

In the case where a filter corresponding to odd-numbered pixels corresponding to the same color is always used, interpolation data at the same pixel position as that of the original position is obtained. The fundamental operation is the same as described above. In this example, linear interpolation is described, but interpolation using other types of weighting is also in the scope of the present invention.

The horizontal direction interpolation circuit 8a generates R and G data signals while data of the RG lines is being processed, and generates B and G data signals while data of the GB lines is being processed. The R-G data signal and the B-G data signal are generated by subjecting the post-interpolation data signals R, B and G which are output from the horizontal direction interpolation circuit 8a to subtraction performed by the adder 8b.

The processing up to this step is controlled by a basic clock signal (although not shown), which represents an input rate of the pixel data from the CCD sensor 1 to the horizontal direction interpolation section 8 in the image processing apparatus 20A.

Hereinafter, the line memory 9 will be described in detail.

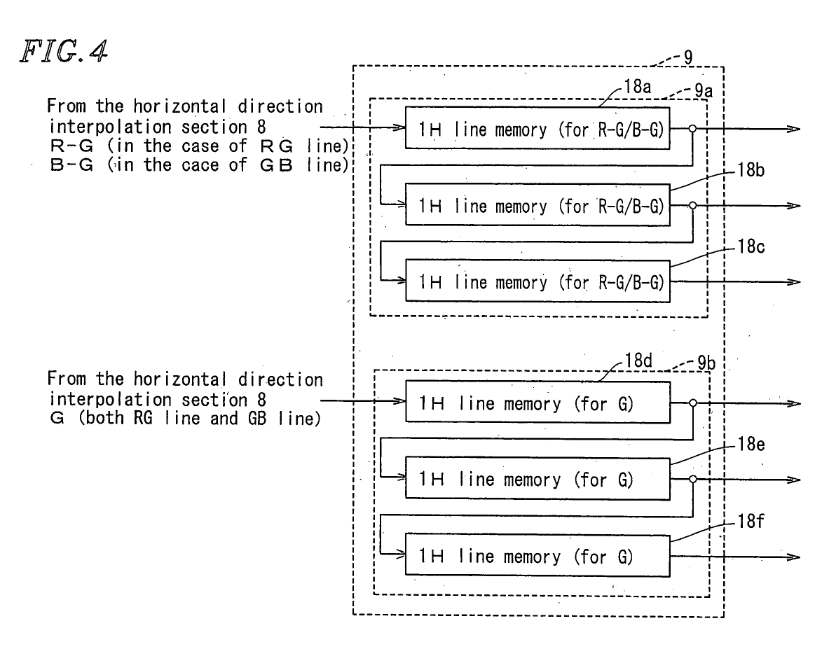

FIG. 4 is a block diagram of the line memory 9.

As shown in FIG. 4, the line memory 9a includes line memories 18a through 18c for R-G and B-G data signals. The line memory 9b includes line memories 18d through 18f for G data signals. In this example, data corresponding to four lines is used for data interpolation. This is why each of the line memories 9a and 9b has 1H (1 horizontal synchronous period)×three lines (six lines in total). In this example, the amount of data corresponding to 1H is the amount of pixel data left in one horizontal period after interpolation. Each of the line memories 9a and 9b has a memory capacity corresponding to 1H×3 lines.

The line memories 9a and 9b are each a FIFO (first-in first-out) memory. Data is output in the order of being input. The three line memories 18a through 18c output data of the same vertical line in parallel. The three line memories 18a through 18c, for-the R-G and in the vertical direction or the horizontal direction GB lines, receive R-G data signals line by line in turn while the data of the RG lines is being processed. The three line memories 18a through 18c receive B-G data signals line by line in turn while the data of the GB lines is being processed.

Data for three lines stored in the line memories 9a and 9b and data for a line which is being processed by the horizontal direction interpolation section 8, i.e., data for four lines, is input to the vertical direction interpolation section 10 in parallel.

In the case where a filter corresponding to the odd-numbered pixels is used, interpolation data at the same pixel position as that of the original position is obtained. The line memories 9a and 9b each include two 1H line memories. The fundamental operation is the same as described above.

The vertical direction interpolation section 10 will be described.

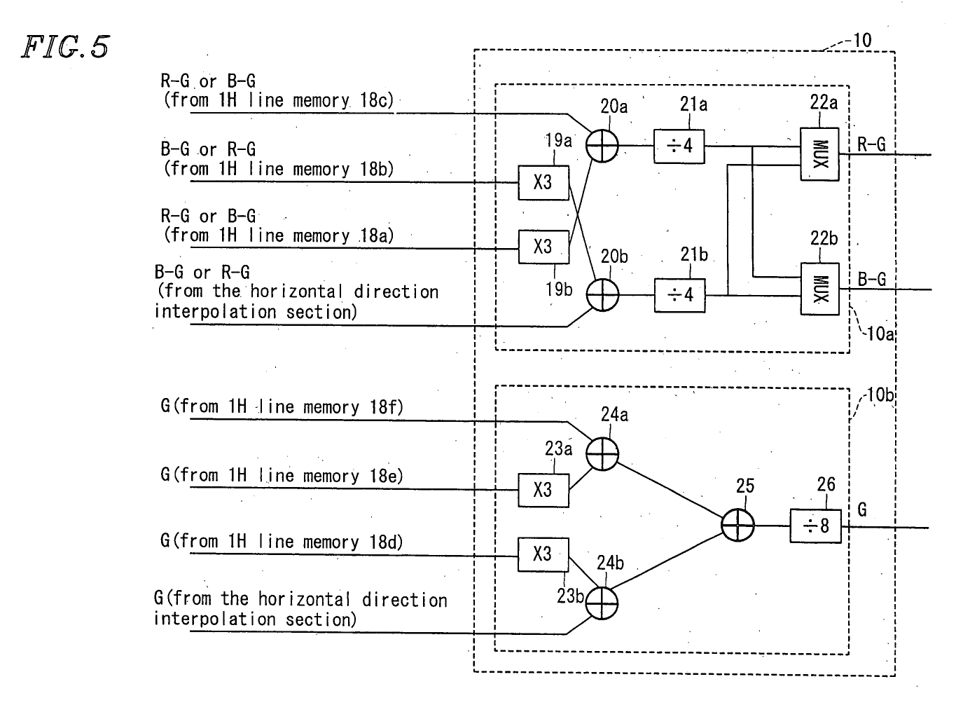

FIG. 5 is a block diagram of the vertical direction interpolation section 10. In this example, linear interpolation is described, but interpolation using other types of weighting is also in the scope of the present invention.

The vertical direction interpolation section 10 includes an interpolation circuit 10a for R-G and B-G data signals and an interpolation circuit 10b for G data signals.

The interpolation circuit 10a uses a filter for obtaining data for one pixel from data for four lines, to obtain R-G and B-G data signals of a line located at the center of the four lines. The interpolation circuit 10a includes multipliers 19a and 19b, adders 20a and 20b, dividers 21a and 21b, and multiplexers 22a and 22b. The interpolation circuit 10a puts a weight of 3 or 1 to post-horizontal interpolation pixel data temporarily stored in the 1H line memories 18a through 18c, adds the weighted data, and divides the added value by 4. Thus, the pixel data at a prescribed pixel position is obtained by linear interpolation.

The interpolation circuit 10a receives post-interpolation data signals R-G and B-G which are supplied from the horizontal direction interpolation circuit 8a via the 1H line memories 18a through 18c and the adder 8b (FIG. 2).

While data of RG lines is being processed, for example, (i) the data signal R-G from a first line (RG line) (an output from 1H line memory 18c) and (ii) a value obtained by putting a weight of 3 to the data signal R-G from a third line (RG line) (an output from 1H line memory 18a) are added together by the adder 20a and then divided by 4. In addition, (iii) a value obtained by putting a weight of 3 to the data signal B-G from a second line (GB line) (an output from 1H line memory 18b) and (iv) the data signal B-G from a fourth line (GB line) (an output from the adder 20a) are added together by the adder 20b and then divided by 4. While data of GB lines is being processed, substantially the same operation is performed.

The value obtained while the data of the RG lines is being processed and the value obtained while the data of the GB lines is being processed are switched over by the multiplexers 22a and 22b. Thus, vertically interpolated data signals R-G and B-G are output.

The signals output from the 1H line memories 18a through 18c and the adder 8b are sequentially supplied to the interpolation circuit 10a, and thus the horizontally interpolated data signals R-G and B-G are output to the right in the horizontal direction sequentially. The same operation is repeated. When the signal data corresponding to one 1H period is completed, the same operation is performed for the next four lines.

The interpolation circuit 10b, which is for the G data signals, uses a filter for obtaining data for one pixel from data for four lines, to obtain the G data signals of a line located at the center of the four lines. The interpolation circuit 10b includes multipliers 23a and 23b, adders 24a, 24b and 25, and a divider 26.The interpolation circuit 10b puts a weight of 3 or 1 to pixel data temporarily stored in the 1H line memories 18d through 18f, adds the weighted data, and divides the added value by 8. Thus, the pixel data at a prescribed pixel position is obtained by linear interpolation.

The interpolation circuit 10b receives post-horizontal direction interpolation. data signals G which are supplied from the 1H line memories 18d through 18f and the horizontal direction interpolation circuit 8a.

An output from the 1H line memory 18f and a value obtained by putting a weight of 3 to the output from the 1H line memory 18f are added together by the adder 24a. A value obtained by putting a weight of 3 to the output from the 1H line memory 18d and an output from the 1H line memory 18d are added together by the adder 24b. The value obtained by the adder 24a and the value obtained by the adder 24b are added by the adder 25, and the added value is divided by 8. Thus, vertically interpolated data signal G is output.

The signals output from the 1H line memories 18d through 18f and the horizontal direction interpolation circuit 8a are sequentially supplied to the interpolation circuit 10b, and thus the horizontally interpolated data signals G are output to the right in the horizontal direction sequentially. The same operation is repeated. When the signal data corresponding to one 1H period is completed, the same operation is performed for the next four lines.

Using the second data signals generated in this manner by the vertical direction interpolation section 10, the luminous and color difference signal generation section 11 obtained a luminous signal Y using the following general expression.

Y=0.587G+0.299R+0.114B

Considering that G≠Y (luminance signal), data signals R-G and B-G can be each considered as a color difference signal and the following approximation can be performed.

CB=R−Y

CR=B−Y

These expressions regarding the color difference signals are modified, such that the color difference signals CB and CR are obtained by the following expressions.

CB=R−Y={(B−G)−(R−G)×0.337}×0.886

CR=B−Y={(R−G)−(B−G)×0.162}×0.701

It is assumed that in a CCD sensor 1 in a digital still camera (solid-state imaging apparatus) having color filters provided in the Bayer arrangement as shown in FIG. 6A, one of two portions vertically arranged (i.e., separated by a horizontal line; for example, an upper portion and a lower portion as shown in FIG. 6B) is irradiated with white light and the other portion is irradiated with no light. In this case, the signal from each of the light receiving elements having an R, G or B filter in the portion irradiated with white light (the upper portion in this example) represents “1”. The signal from each of the light receiving elements having an R, G or B filter in the portion irradiated with no light (the lower portion in this example) represents “0”. Especially when data which is output from the CCD sensor 1 is thinned out in the vertical direction, the correlation between these portions is often weakened.

In this example, interpolation is performed to such a data signal using horizontal direction interpolation filters shown in FIG. 6C and vertical direction interpolation filters shown in FIG. 6D.

With reference to FIG. 6E, the post-horizontal direction interpolation pixel data at point A indicated by a black circle is as follows.

G=(1×0+1×3+1×0+1×1)/4=1

R=(1×1+1×0+1×3+1×0)/4=1

R−G=0

The post-horizontal direction interpolation pixel data at point B indicated by a black circle is as follows.

G=(1×1+1×0+1×3+1×0)/4=1

B=(1×0+1×3+1×0+1×1)/4=1

The post-horizontal direction interpolation pixel data at point C indicated by a black circle is as follows.

G=(0×0+0×3+0×0+0×1)/4=0

R=(0×1+0×0+0×3+0×0)/4=0

R−G=0

The post -horizontal direction interpolation pixel data at point D indicated by a black circle is as follows.

G=(0×1+0×0+0×3+0×0)/4=0

B=(0×0+0×3+0×0+0×1)/4=0

B−G=0

The first color signals obtained by the horizontal direction interpolation are subjected to the vertical direction interpolation. The post-vertical direction interpolation pixel data at point E indicated by a black circle in FIG. 6E is as follows.

R−G=(0×1+0×0+0×3+0×0)/4=0

B−G=(0×0+9×3+0×0+0×1)/4=0

G=(1×1+1×3+1×3+1×1)/8=0.5.

Using the second signals obtained by the vertical direction interpolation, the luminance signal Y and the color difference signals CB and CR are obtained as follows.

$$Y = 0.301 R + 0.587 G + 0.114 B \\ = 0.301 ( R - G ) + 0.114 ( B - G ) + G \\ = 0.5$$

B−G=0

R−G=0

Thus,

$$CB = B - Y \\ = ( - 0.299 R - 0.587 G + 0.886 B ) \times 0.564 \\ = ( ( B - G ) - ( R - G ) \times 0.337 ) \times 0.5 \\ = 0$$

$$CR = R - Y \\ = ( 0.701 R - 0.587 G - 0.114 B ) \times 0.713 \\ = ( ( R - G ) - ( B - G ) \times 0.163 ) \times 0.5 \\ = 0$$

According to the image processing apparatus 20A of this example, even when the correlation between two pieces of pixel data in the CCD sensor 1 adjacent in the vertical direction is weakened as a result of data being thinned out in the vertical direction, the color difference signals CB and CR are both 0 at the point E at the border between the portion irradiated with white light and the portion irradiated with no light. Thus, a false color is not likely to be generated.

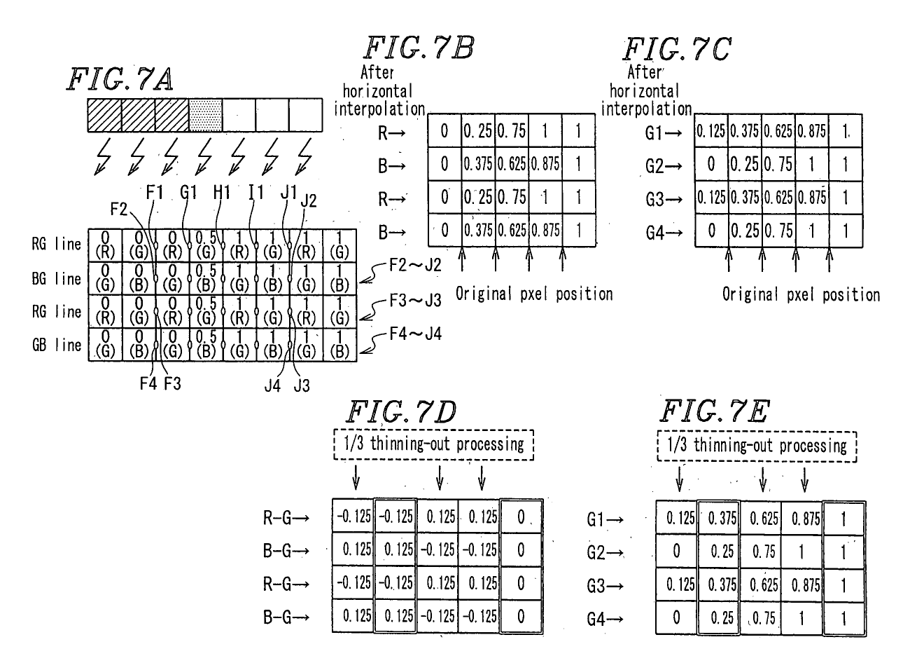

FIGS. 7A through 7E illustrate a calculation process of a luminance signal and color difference signals when a portion of the CCD sensor 1 is irradiated with white light and another portion of the CCD sensor 1 is irradiated with no light.

In FIG. 7A, one of two portions of the CCD sensor 1 horizontally arranged (i.e., separated by a vertical line; for example, a left portion and a right portion in this example) is irradiated with white light, and the other portion is irradiated with no light. In this case, the signal from each of the light receiving elements having an R, G or B filter in the portion irradiated with white light (the right portion in this example) represents “1”. The signal from each of the light receiving elements having an R, G or B filter in the portion irradiated with no light (the left portion in this example) represents “0”. At the border between the two portions, the signal from each of the light receiving elements having an R, G or B filter represents “0.5”.

In this example, interpolation is performed to such a data signal using horizontal direction interpolation

filters shown in FIG. 6C and vertical direction interpolation filters shown in FIG. 6D. In FIG. 7A, the black circles each represent a point at which the pixel data value is obtained by horizontal direction interpolation. In this case, no pixel data is thinned out in the horizontal direction before the interpolation, and an optical low pass filter is used for the CCD sensor 1. Therefore, the pixel data value does not rapidly change between two adjacent pieces of pixel data, and the correlation therebetween is relatively strong.

With reference to FIGS. 7A through 7C, the post-horizontal direction interpolation pixel data at point F1 (line 1) and point F3 (line 3) in FIG. 7A is as follows.

G=(0×0+0×3+0×0+0.5×1)/4=0.125

R=(0×1+0×0+0×3+0.5×0)/4=0

R−G=−0.125

The post-horizontal direction interpolation pixel data at point F2 (line 2) and point F4 (line 4) is as follows.

G=(0×1+0×0+0×3+0.5×0)/4=0

B=(0×0+0×3+0×0+0.5×1)/4=0.125

B−G=0.125

The post-horizontal direction interpolation pixel data at points G1 and G3 is as follows.

G=(0×1+0×0+0.5×3+1×0)/4=0.375

R=(0×0+0×3+0.5×0+1×1)/4=0.25

R−G−0.125

The post-horizontal direction interpolation pixel data at points G2 and G4 is as follows.

G=(0×0+0×3+0.5×0+1×1)/4=0.25

B=(0×1+0×0+0.5×3+1×0)/4=0.375

B−G=0.125

The post-horizontal direction interpolation pixel data at points H1 and H3 is as follows.

G=(0×0+0.5×3+1×0+1×1)/4=0.625

R=(0×1+0.5×0+1×3+1×0)/4=0.75

R−G=0.125

The post-horizontal direction interpolation pixel data at points H2 and H4 is as follows.

G=(0×1+0.5×0+1×3+1×0)/4 0.75

B=(0×0+0.5×3+1×0+1×1)/4=0.625

B−G=0.125

The post-horizontal direction interpolation pixel data at points I1 and I3 is as follows.

G=(0.5×1+1×0+1×3+1×0)/4=0.875

R=(0.5×0+1×3+1×0+1×1)/4=1

R−G=0.125

The post-horizontal direction interpolation pixel data at points I2 and I4 is as follows.

G=(0.5×0+1×3+1×0+1×1)/4=1

B=(0.5×1+1×0+1×3+1×0)/4=0.875

B−G=0.125

The post-horizontal direction interpolation pixel data at points J1 and J3 is as follows.

G=(1×0+1×3+1×0+1×1)/4=1

R=(1×1+1×0+1×3+1×0)/4=1

R−G=0

The post-horizontal direction interpolation pixel data at points J2 and J4 is as follows.

G=(1×1+1×0+1×3+1×0)/4=1

B=(1×0+1×3+1×0+1×1)/4=1

B−G=0

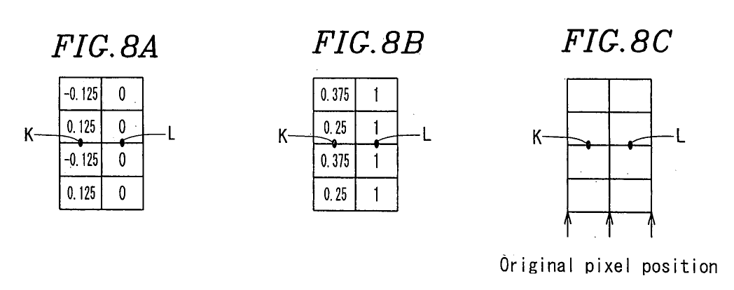

The first color signals (FIGS. 7B and 7C) after the horizontal direction interpolation is performed is subjected to ⅓ thinning-out processing. Namely, data indicated by the arrows in FIGS. 7D and 7E is thinned out and the data in the thick-lined rectangles is left. Then, vertical interpolation is performed by weighting using the filter shown in FIG. 6D. Then, the post-vertical interpolation pixel data at point K in the left side of FIGS. 8A through 8C is as follows.

R−G=(−0.125×1+0.125×0−0.125×3+0.125×0)/4 =0.125

B−G=(−0.125×0+0.125×3−0.125×0+0.125×1)/4 =0.125

G=(0.375×1+0.25×3+0.375×3+0.25×1)/8=0.313

The post-vertical interpolation pixel data at point L in the right side of FIGS. 8A through 8C is as follows.

R−G=(0×1+0×0+0×3+0)/4=0

B−G=(0×0+0×3+0×0+0×1)/4=0

G=(1×1+1×3+1×3+1×1)/8=1

Using the second data signals obtained by the vertical direction interpolation, a luminous signal Y and color difference signals CB and CR at point K (in the left side of FIG. 8C) are obtained as follows.

$$Y = 0.301 R + 0.587 G + 0.114 B \\ = 0.301 ( R - G ) + 0.114 ( B - G ) + G \\ = 0.086$$

$$B - G = - 0.125$$

$$R - G = 0.125$$

Thus,

$$CB = B - Y \\ = ( - 0.299 R - 0.587 G + 0.886 B ) \times 0.564 \\ = ( ( B - G ) - ( R - G ) \times 0.337 ) \times 0.5 \\ = 0.084$$

$$CR = R - Y \\ = ( 0.701 R - 0.587 G - 0.114 B ) \times 0.713 \\ = ( ( R - G ) - ( B - G ) \times 0.163 ) \times 0.5 \\ = - 0.073$$

A luminous signal Y and color difference signals CB and CR at point L (in the right side of FIG. 8C) are obtained as follows.

$$\begin{matrix}Y = 0.301 R + 0.587 G + 0.114 B \\ = 0.301 ( R - G ) + 0.114 ( B - G ) + G \\ = 1\end{matrix}$$

$$B - G = 0$$

$$R - G = 0$$

Thus,

$$\begin{matrix}CB = B - Y \\ = ( - 0.299 R - 0.587 G + 0.886 B ) \times 0.564 \\ = ( ( B - G ) - ( R - G ) \times 0.337 ) \times 0.5 \\ = 0\end{matrix}$$

$$\begin{matrix}CR = R - Y \\ = ( 0.701 R - 0.587 G - 0.114 B ) \times 0.713 \\ = ( ( R - G ) - ( B - G ) \times 0.163 ) \times 0.5 \\ = 0\end{matrix}$$

According to the image processing apparatus 20A of this example, even when one of two portions horizontally arranged (i.e., separated by a vertical line; for example, a left portion and a right portion) is irradiated with light and the other portion is irradiated with no light, a false color is not likely to be generated with the level of the false color being low. The reason is that color difference signals are obtained using pre-thinning-out pixel data. Before the thinning-out processing, the pieces of pixel data adjacent to each other have a relatively strong correlation.

In this example, the line memory 9, the vertical direction interpolation section 10 and the luminance and color difference signal generation section 11 receive an intermittent clock signal 12A which is generated by the thinning-out clock control section 12. In synchronization with the intermittent clock signal 12A, thinning-out processing of pixel data is performed. For reducing the size of data to ⅓, for example, the thinning-out clock control section 12 generates the intermittent clock signal 12A for one clock per three clocks of the basic clock signal, and supplies the intermittent clock signal 12A to the line memory 9, the vertical direction interpolation section 10 and the luminance and color difference signal generation section 11. The basic clock signal represents the timing at which pixel data is input from the CCD sensor 1.

The thinning-out clock signal control section 12 can be realized with a simple structure including, for example, a counter, an adder and a comparator. Alternatively, the thinning-out clock signal control section 12 may be realized by setting an intermittent pattern of the clock signal in a register and reading the data from the register bit by bit. Using the intermittent signal 12A, the pixel data is thinned out. Thus, the operating frequency of the line memory 9, the vertical direction interpolation section 10 and the luminance and color difference signal generation section 11 is reduced. Thus, the power consumption can be significantly reduced.

As described above, according to the present invention, an imaging device such as the CCD sensor 1 outputs pixel data without thinning out data in the vertical direction. The horizontal direction interpolation section 8 performs horizontal direction interpolation so as to thin out the pixel data in the horizontal direction. Then, pieces of pixel data of a plurality of lines having a strong correlation are stored in the line memory 9. The vertical direction interpolation section 10 performs vertical direction interpolation so as to thin out the pixel data in the vertical direction. An imaging device such as the CCD sensor 1 may output pixel data which has been thinned out in the vertical direction. In this case, the horizontal direction interpolation section 8 performs horizontal direction interpolation so as to thin out the pixel data in the horizontal direction. Then, pieces of pixel data of a plurality of lines are stored in the line memory 9. The vertical direction interpolation section 10 performs vertical direction interpolation. In this manner, generation of a false color is suppressed, and the amount of processing performed by the image processing apparatus is reduced, to decrease the power consumption. The circuit scale such as the capacity of the line memory or the like is also reduced. Thus, the size of the imaging device is decreased.

Use of an intermittent clock signal lowers the operating frequency of the image processing apparatus and further reduces the power consumption. As such, the present invention is optimal for a battery-operated portable imaging device, which is required to have low power consumption. The present invention is especially suitable to a digital still camera. In addition, input of an intermittent clock signal to a line memory causes data to be thinned out in the line memory.

According to the present invention, first data signals R-G, B-G and G are obtained by performing horizontal direction interpolation, and the first data signals are thinned out in the horizontal direction and then vertical direction interpolation is performed. Then, a luminance signal Y and color difference signals CB and CR are generated. This can significantly suppress generation of a false color generated by thinning out data in the vertical direction using the imaging device and also suppress generation of a false color generated by thinning out data in the horizontal direction before the data is stored in the line memory.

Use of an intermittent clock as an operation clock for the line memory, the vertical direction interpolation section and the luminance and color difference signal generation section significantly suppresses the power consumption.

Various other modifications will be apparent to and can be readily made by those skilled in the art without departing from the scope and spirit of this invention. Accordingly, it is not intended that the scope of the claims appended hereto be limited to the description as set forth herein, but rather that the claims be broadly construed.

What is claimed is:

1. An image processing apparatus for generating a luminance signal and color difference signals based on pixel data which is input from an imaging device, wherein:
the imaging device includes a plurality of light receiving sections arranged in rows and columns;
the plurality of light receiving sections each include a color filter; and
the image processing apparatus comprises:
a horizontal direction interpolation section for performing data interpolation in a horizontal direction using a plurality of pieces of pixel data adjacent to a first pixel position in the horizontal direction to generate a first color signal;
a line memory section f or storing the first color signal in units of a plurality of lines;
a vertical direction interpolation section for performing data interpolation in a vertical direction using a plurality of pieces of pixel data, among pieces of data output from the line memory section, adjacent to a second pixel position in the vertical direction to generate a second color signal; and
a luminance and color difference signal generation section for generating a luminance signal and color difference signals based on the second color signal.

2. An image processing section according to claim 1, wherein the horizontal direction interpolation section includes:
a horizontal direction interpolation circuit for, when the color filters are provided in a Bayer arrangement, outputting an R data signal based on an RG line, outputting a B data signal based on a GB line, and outputting a G data signal based on the RG line and the GB line; and
a differential signal output section for outputting a first differential signal based on the R data signal and the G data signal and outputting a second differential signal based on the B data signal and the G data signal.

3. An image processing apparatus according to claim 2, wherein the horizontal direction interpolation section includes:
a four-stage shift register section for sequentially holding a plurality of pieces of pixel data;
a first addition section for adding pieces of data output from odd-numbered stages of the shift register;
a second addition section for adding pieces of data output from even-numbered stages of the shift register;
a first selection section for selecting one of the data output from the first addition section and the data output from the second addition section so as to output one of an R data signal and a B data signal; and
a second selection section for selecting one of the data output from the first addition section and the data output from the second addition section so as to output a G data signal.

4. An image processing apparatus according to claim 1, wherein the line memory section thins out the first color signal in the horizontal direction and stores the thinned-out first color signal therein.

5. An image processing apparatus according to claim 2, wherein the line memory-section includes:
a first line memory for receiving the first differential signal and the second differential signal;
a second line memory for receiving the data signal output from the first line memory;
a third line memory for receiving the data signal output from the second line memory;
a fourth line memory for receiving the G data signal;
a fifth line memory for receiving the data signal output from the fourth line memory; and
a sixth line memory for receiving the data signal output from the fifth line memory.

6. An image processing apparatus according to claim 5, wherein the vertical direction interpolation section receives the first differential signal, the second differential signal, the G data signal, and the data signal from each of the first through sixth line memories.

7. An image processing apparatus according to claim 4, further comprising an intermittent clock signal generation section for generating an intermittent clock signal having a frequency lower than a frequency of a clock signal which is input to the horizontal direction interpolation section; wherein the line memory section, the vertical direction interpolation section, and the luminance and color difference signal generation section operate based on the intermittent clock signal.

8. An image processing apparatus according to claim 1, wherein:
the horizontal direction interpolation section generates the first color signal using a filter for weighting at least one of the plurality of pieces of pixel data adjacent to the first pixel position in the horizontal direction, and
the vertical direction interpolation section generates the second color signal using a filter for weighting at least one of the plurality of pieces of pixel data adjacent to the second pixel position in the vertical direction.

9. A digital still camera, comprising:
an imaging device; and
an image processing apparatus for generating a luminance signal and color difference signals based on pixel data which is input from the imaging device, wherein:
the imaging device includes a plurality of light receiving sections arranged in rows and columns;
the plurality of light receiving sections each include a color filter; and
the image processing apparatus comprises:
a horizontal direction interpolation section for performing data interpolation in a horizontal direction using a plurality of pieces of pixel data adjacent to a first pixel position in the horizontal direction to generate a first color signal;
a line memory section for storing the first color signal in units of a plurality of lines;
a vertical direction interpolation section for performing data interpolation in a vertical direction using a plurality of pieces of pixel data, among pieces of data output from the line memory section, adjacent to a second pixel position in the vertical direction to generate a second color signal; and
a luminance and color difference signal generation section for generating a luminance signal and color difference signals based on the second color signal.

10. An image processing method for generating a luminance signal and color difference signals based on pixel data which is input from an imaging device, wherein:
the imaging device includes a plurality of light receiving sections arranged in rows and columns;
the plurality of light receiving sections each include a color filter; and
the image processing method comprises:
a first step of performing data interpolation in a horizontal direction using a plurality of pieces of pixel data adjacent to a first pixel position in the horizontal direction to generate a first color signal;
a second step of storing the first color signal in units of a plurality of lines;
a third step of performing data interpolation in a vertical direction using a plurality of pieces of pixel data, among pieces of data represented by the first color signal, adjacent to a second pixel position in the vertical direction to generate a second color signal; and
a fourth step of generating a luminance signal and color difference signals based on the second color signal.

11. An image processing method according to claim 10, further comprising the step of generating an intermittent clock signal having a frequency lower than a frequency of a clock signal used at the first step, wherein the second through fourth steps are executed based on the intermittent clock signal.
